(19) United States
(12) Patent Application Publication
(10) Pub. No.: US 2013/0170377 A1
(43) Pub. Date: Jul. 4, 2013

(54) APPARATUS AND METHOD FOR IDENTIFYING APPLICATION USING PACKET IN COMMUNICATION SYSTEM

(71) Applicant: Samsung Electronics Co., Ltd, Gyeonggi-do (KR)

(72) Inventors: Jun-Seok Hong, Gyeonggi-do (KR); Sang-lg Rho, Gyeonggi-do (KR); Seung-Min Baek, Gyeonggi-do (KR); Ho-Cheol Lee, Suwon-si (KR); Kyu-Ho Cho, Gyeonggi-do (KR); Jae-Jin Kim, Gyeonggi-do (KR); Jong-Hun Kim, Gyeonggi-do (KR)

(73) Assignee: Samsung Electronics Co., Ltd, Gyeonggi-do (KR)

(21) Appl. No.: 13/734,044

(22) Filed: Jan. 4, 2013

(30) Foreign Application Priority Data
Jan. 4, 2012 (KR) 10-2012-0000932

(51) Int. Cl. H04L 29/06

(52) U.S. Cl. CPC H04L 69/22
USPC 370/252

(57) ABSTRACT

An apparatus and a method for identify an application to which a packet flow belongs in a communication system. In the method, characteristic information of a first application is selected. Bit lines of a position designated by a mask included in the characteristic information are examined from packets transferred via the packet flow. A ratio of the number of examination results of coincidence to the number of all input packets is calculated. When the ratio exceeds a first threshold included in the characteristic information, it is determined that the packet flow belongs to the first application.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 4, 2012 and assigned Serial No. 10-2012-0000932, the entire disclosure of which is hereby incorporated by reference.

### TECHNICAL FIELD OF THE INVENTION

The present disclosure relates to a communication system.

### BACKGROUND OF THE INVENTION

Recently, as use of a smart phone increases rapidly, traffic of a mobile communication network rapidly increases as in the existing wired Internet Protocol (IP) network. For efficient network resource operation via audio/video streaming traffic control, etc. and also for check of a Voice over IP (VoIP) service and a messaging service that replace the existing wired communication network, a demand for a technique for analyzing content of a packet to analyze which service is provided is increasing.

A technology for analyzing a service identifies whether header information of Transmission Control Protocol/User Datagram Protocol (TCP/UDP) such as a port number and a specific character string pattern included in data exists, or uses the length and the number of specific packets, etc. Alternatively, a protocol operation method and statistical information, etc. may be utilized. When an application always uses a constant port number or when a specific character string pattern is used by packet data, the above method may be easily applied. However, recent applications adopt a policy of encrypting data in order to protect content of the data or using a variable port number in order to avoid a state where service is not allowed due to blocking of a port of a specific number.

In the case where data is encrypted or a variable port number is used, the above-described service analyzing technique cannot guarantee a proper analysis result. Therefore, an alternative for identifying an application that uses encrypted data needs to be proposed.

### SUMMARY OF THE INVENTION

To address the above-discussed deficiencies of the prior art, it is a primary object to provide an apparatus and a method for identifying an application in a communication system.

Another aspect of the present disclosure is to provide an apparatus and a method for identifying an application using a packet in a communication system.

Still another aspect of the present disclosure is to provide an apparatus and a method for identifying an application by analyzing an encrypted packet in a communication system.

Yet another aspect of the present disclosure is to provide an apparatus and a method for identifying an application by determining sameness of a specific bit inside a packet in a communication system.

In accordance with an aspect of the present disclosure, a method for identifying an application to which a packet flow belongs is provided. The method includes selecting characteristic information of a first application, examining bit lines of a position designated by a mask included in the characteristic information from packets transferred via the packet flow, calculating a ratio of the number of examination results of coincidence to the number of all input packets, and when the ratio exceeds a first threshold included in the characteristic information, determining that the packet flow belongs to the first application.

In accordance with another aspect of the present disclosure, an apparatus for identifying an application to which a packet flow belongs is provided. The apparatus includes a storage for storing characteristic information corresponding to at least one application, and a controller for selecting characteristic information of a first application, examining bit lines of a position designated by a mask included in the characteristic information from packets transferred via the packet flow, calculating a ratio of the number of examination results of coincidence to the number of all input packets, and when the ratio exceeds a first threshold included in the characteristic information, determining that the packet flow belongs to the first application.

Other aspects, advantages and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a logical structure of an application detection engine in a communication system according to an exemplary embodiment of the present disclosure;

FIG. 2 illustrates an example of packet masking in a communication system according to an exemplary embodiment of the present disclosure;

FIG. 3 illustrates a flowchart of a process for identifying an application in a communication system according to an exemplary embodiment of the present disclosure; and

FIG. 4 illustrates a block diagram of an application identifying apparatus in a communication system according to an exemplary embodiment of the present disclosure.

Throughout the drawings, like reference numerals will be understood to refer to like parts, components and structures.

### DETAILED DESCRIPTION OF THE INVENTION

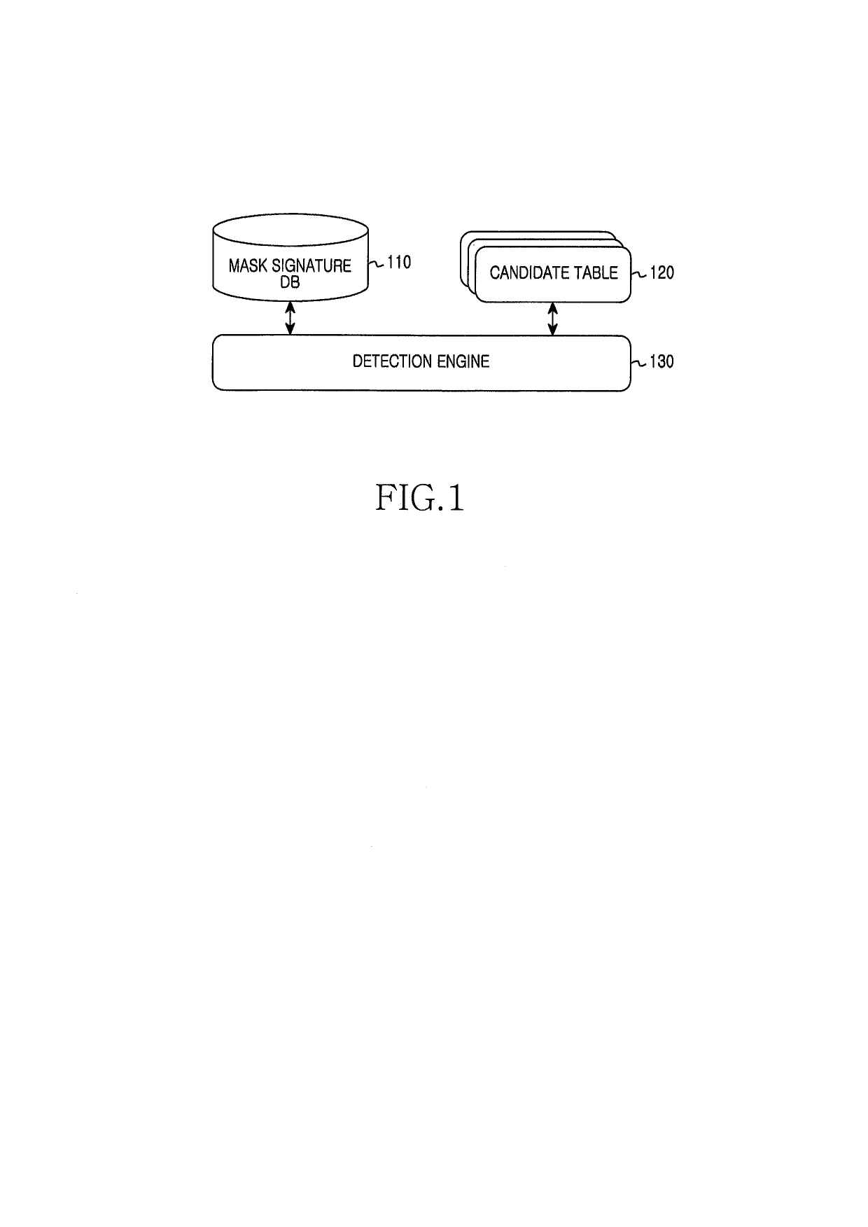

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of exemplary embodiments of the invention as defined by the claims and their equivalents. The description includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present disclosure relates to a method for identifying application using packet and an electronic device thereof. Exemplary embodiments of the present disclosure provide a technology for analyzing a packet to identify an application in a communication system. The present disclosure checks whether data is the same depending on a packet data position of an application that uses encrypted data. The present disclosure proposes a bit Mask-based application Detection Engine (MDE) that raises a detection degree of an application service.

A mask-based application detection engine described by the present disclosure may be configured as in FIG. 1. FIG. 1 illustrates a logical structure of an application detection engine in a communication system according to an exemplary embodiment of the present disclosure. Referring to FIG. 1, the application detection engine includes a mask signature database (DB) 110 for storing at least one mask signature defining a detection condition, a matching candidate table 120 for storing comparison results of packets using the mask signature, and storing and managing a client IP address expected as a specific application and a relevant application determining condition, and a detection engine 130 for comparing and analyzing packets using the mask signature.

The mask signature DB 110 includes a mask signature. The mask signature is characteristic information defining variables used for application detection. Specifically, the characteristic information is bit pattern information. For example, the variables may include a bit mask representing a position where values positioned at a specific position of packet data seem to be identical on a bit basis with respect to respective packets, and a detection success probability, which is a ratio of the number of packets that match with the mask defined above to the number of all packets. Also, besides this, the mask signature may further define various values used for comparison. The mask signature is defined for each application to be detected. Table 1 represents an example of a mask signature.

TABLE 1

```
mde{ mask: <32byte mask hex value>;
    pattern_hit_rate:<hit rate>;
    min_count:<value>;
    max_count:<value>;
    skip_packet_number:<value>;
    increase:<start_offset, size, number>;
    size_check;}
```

Referring to Table 1, ‘mask’ designates a position of a bit to be compared between packets, and ‘pattern_hit_rate’ denotes a rate in which comparison results should coincide for being determined as a relevant application. ‘min_count’ denotes the number of input packets that allows start of rate calculation, and ‘max_count’ denotes the number of input packets that allows stop of rate calculation. ‘skip_packet_number’ denotes the number of input packets that allows start of comparison operation. A comparison operation is not performed on initial input packets corresponding to the number of packets defined by ‘skip_packet_number’. ‘increase’ may be used when all or partial values of bit lines of a position designated by ‘mask’ in a plurality of packets change in a predetermined pattern, and includes ‘start_offset’, ‘size’, and ‘number’. ‘start_offset’ designates a position of a portion having an increasing or decreasing value, ‘size’ designates a length of an increasing or decreasing portion, and ‘number’ designates an amount of change. ‘number’ may be a positive number or a negative number. A positive number denotes an increase of a value, and a negative number denotes a decrease of a value. ‘size_check’ may be used in the example where a packet size is constant, and designates a relevant constant size.

That is, in the example where a mask signature as in Table 1 is used, a ratio of the number of packets where all data to which a mask is to be applied have the same value to all packets of a specific packet flow should be equal to or greater than a predetermined value, that is, a value set by ‘pattern_hit_rate’. At this point, ratio comparison starts when the number of accumulated packets is ‘min_count’. When a detection condition is not met until the number of accumulated packets exceeds ‘max_count’, a detection procedure is stopped. In the example where a packet that does not match with a mask exists in an initial stage of a packet flow, a signature designer may set a value to ‘skip_packet_number’, thereby allowing packet mask comparison to be performed after the relevant set value. In the example where a portion of a specific position in a packet changes in a predetermined pattern, a signature designer may designate a position of a portion showing a changing pattern using ‘start_offset’ and ‘size’. In the example where an amount of change is constant, the signature designer may set the change value to ‘number’. ‘size_check’ may be used when a condition where packet data of a specific flow should be always constant is added.

In case of generating a mask signature, ‘mask’ and ‘pattern_hit_rate’ should be defined indispensably, and the rest of variables are selective. However, a default value may be defined for a portion of variables. For example, in the example where a value of ‘min_count’ is not set, a rate may be calculated from 32^{nd} packet comparison. Also, in the example where ‘max_count’ is not set, comparison may be ended at a 48^{th} packet. In the example where ‘skip_packet_number’ is not set, comparison may start from a third packet.

The matching candidate table 120 extracts and stores M bytes of recent N packets of a flow serving as a monitoring object. For example, N may be 3 and M may be 32. Also, an extract position may be a front end of a packet. In addition, the matching candidate table 120 stores comparison results by the detection engine 130.

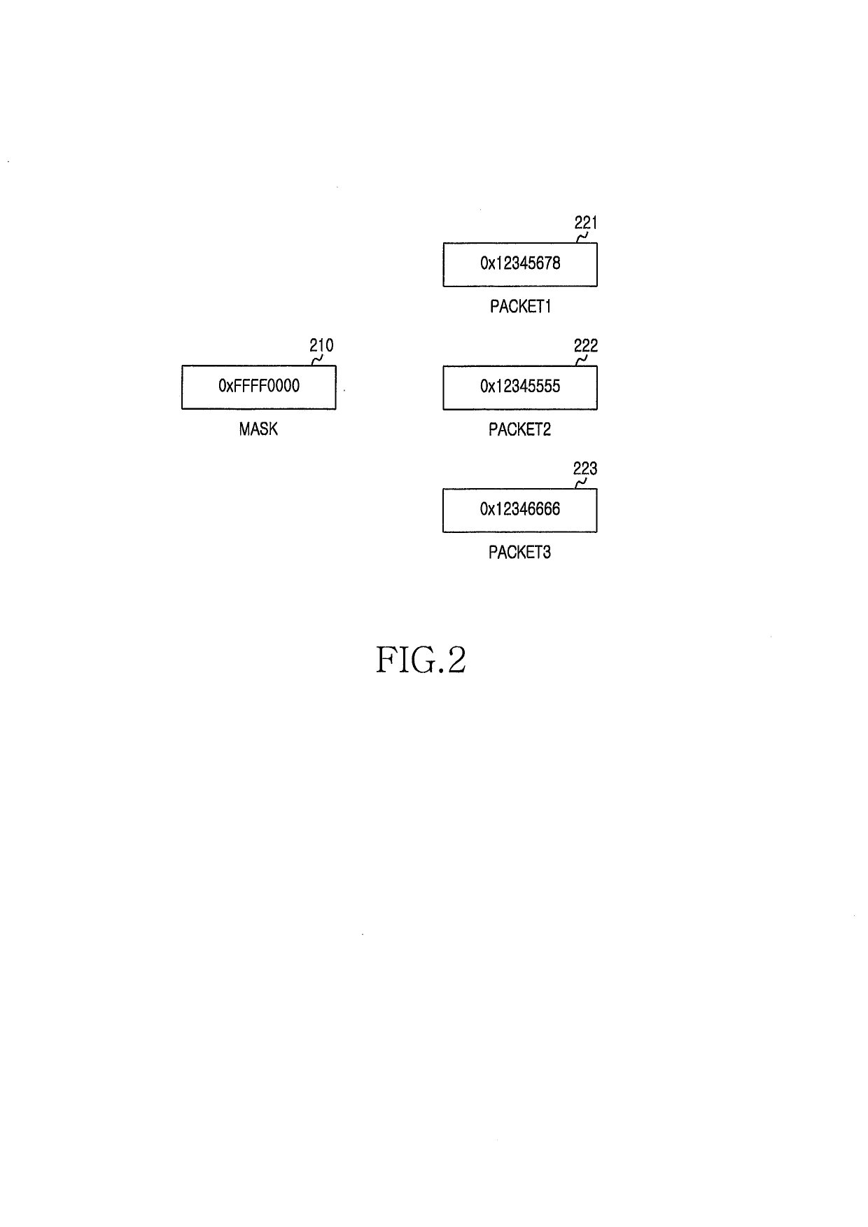

The detection engine 130 identifies an application in a flow through comparison using a mask value. All packets pass through the detection engine 130 until they are identified, and the detection engine 130 compares whether bit lines of a position designated by a mask pattern coincide, and stores comparison results in the matching candidate table 120 of a flow to which a relevant packet belongs. In the example where a mask pattern coincides and is detected, the detection engine 130 may determine that a flow forming a pair with a relevant flow uses a detected application. The flow forming a pair denotes a pair of an uplink and a downlink. Comparison of packets using a mask pattern is illustrated in FIG. 2. FIG. 2 illustrates an example of packet masking in a communication system according to an exemplary embodiment of the present disclosure. For convenience in description, FIG. 2 illustrates an example where 4 bytes, not 32 bytes are extracted, as an example. Referring to FIG. 2, a mask 210 is defined as ‘0xFFFF0000’. That is, the mask 210 defines that front 2 bytes of 4 bytes extracted from packets inside a flow should be the same. In the example where a packet 1 221, a packet 2 222, and a packet 3 223 are input to the detection engine, since the front 2 bytes of the packet 1 221, the packet 2 222, and the packet 3 223 are all the same as ‘1234’, the comparison result becomes ‘coincidence’.

As illustrated in FIG. 2, the detection engine 130 compares bit lines of a position designated by a mask to determine whether they coincide with one another. In addition, the detection engine 130 identifies an application depending on a condition defined by a mask signature stored in the mask signature DB 110.

As described above, the apparatus that identifies an application may be included in an object processing a layer to which a packet used for examination belongs. For example, in case of identifying an application using an IP packet, the apparatus may be included in any node as far as the apparatus performs an operation of an IP layer. For example, the apparatus may be included in a terminal, or may be included in a specific node processing an IP packet on a network.

Hereinafter, the present disclosure describes an operation and configuration of an apparatus for identifying an application by analyzing a packet in detail with reference to the drawings.

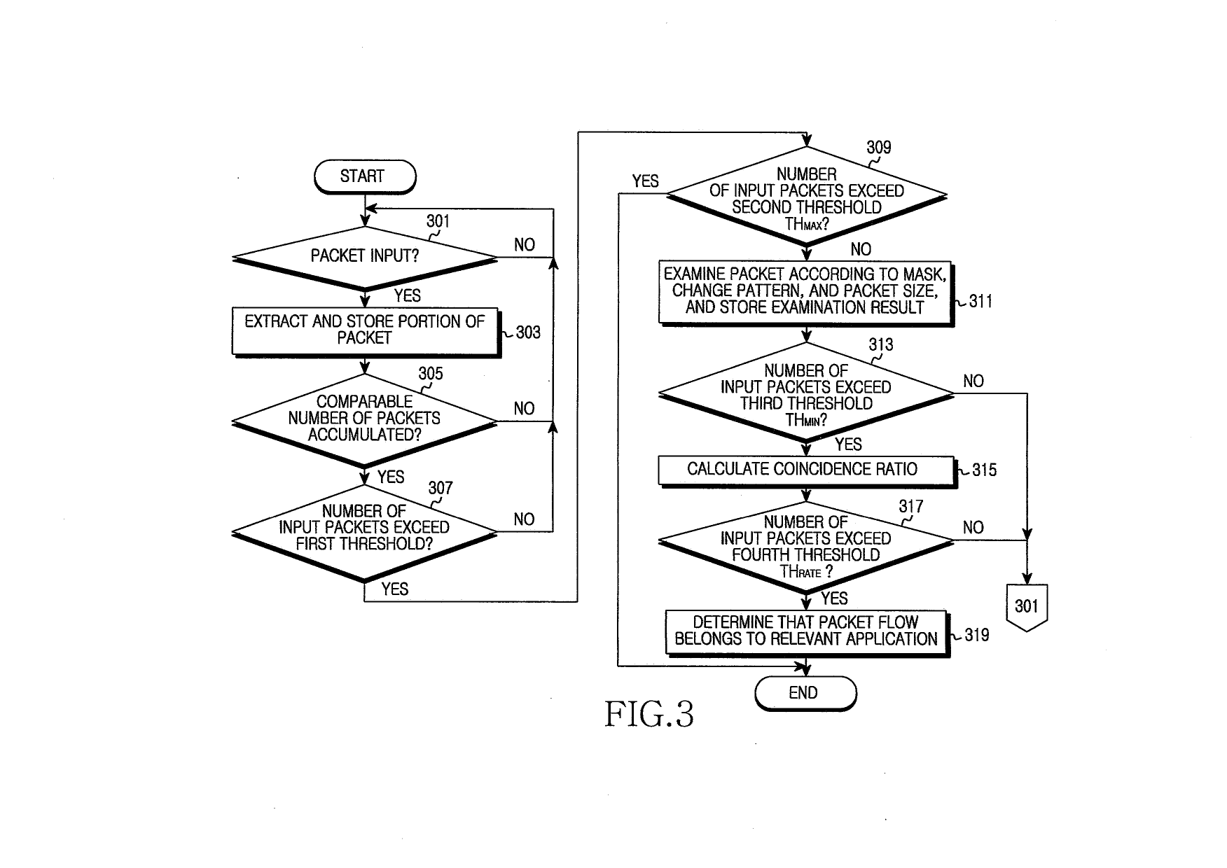

FIG. 3 illustrates a flowchart of a process for identifying an application in a communication system according to an exemplary embodiment of the present disclosure. For convenience in the description, the present disclosure denotes a subject for identifying the application as a ‘detector’.

Referring to FIG. 3, the detector determines whether a packet is input in step 301. The packet may be a packet that belongs to a specific transmission flow set by an apparatus including the detector, or a packet that belongs to a specific reception flow. That is, since identification of the application is performed on a specific flow, the detector receives packets transferred via a specific transmission or reception flow. Though not illustrated in FIG. 3, before step 301, the detector selects a plurality of characteristic information defined in advance, that is, characteristic information corresponding to one application among a plurality of mask signatures, that is, a mask signature.

When the packet is input, the detector proceeds to step 303 to extract and store a portion of the input packet. A position and a size of the extracted portion of the packet conform to those defined in advance. For example, a portion of the packet may be front M bytes. For example, M may be 32. According to another embodiment of the present disclosure, an entire packet may be stored. In the example where the detector stores only a limited number of packets, the detector discards an old packet and stores the packet input in step 301.

Subsequently, the detector proceeds to step 305 to determine whether a comparable number of packets has been accumulated. That is, the detector compares a predetermined number of packets. For example, the detector may compare three packets. In this example, one examination result is derived from the three packets. According to another embodiment of the present disclosure, the detector may compare two or four or more packets.

When the comparable number of packets has been accumulated, the detector proceeds to step 307 to determine whether the number of input packets exceeds a first threshold. Here, the first threshold is a variable defined for skipping the examination with respect to a predetermined number of packets after a flow starts. For example, the first threshold is the same as ‘skip_packet_number’ of Table 1. For example, in the example where a predetermined number of packets transferred right after the start of a flow deviates from a common pattern, the first threshold may be used. If the first threshold is ‘0’, step 307 may be omitted. That is, until packets are input as many as the first threshold, the detector performs only storing and performs examination on packets input afterward.

When the number of input packets exceeds the first threshold, the detector proceeds to step 309 to determine whether the number of input packets exceeds a second threshold. The second threshold defines a threshold of packets for continuing the present procedure. For example, the second threshold is the same as ‘max_count’ of Table 1. That is, since infinite repetition of examination due to non-satisfaction of an identification condition of an application is not desirable, the second threshold prevents an infinite repetitive operation. It is preferred that the second threshold is defined by statistics. When the number of input packets exceeds the second threshold, the detector ends the present procedure. Though not shown in FIG. 3, afterward, the detector excludes a mask signature currently in use from candidates, and may perform the present procedure using characteristic information, that is, a mask signature corresponding to a different application.

In contrast, when the number of input packets does not exceed the second threshold, the detector proceeds to step 311 to examine a packet according to a mask, a change pattern, and a packet size, and store an examination result. For the examination, the packet input in step 301 and at least one packet stored in advance are used. Here, the change pattern and the packet size may not be defined. In the example where only the mask is defined, the detector determines whether bit lines designated by the mask between a plurality of packets coincide. For example, in the example where three packets are used for examination, a logic for determining coincidence of the bit lines may be defined by Equation (1).

PATTERN=NEGATE(p₀ XOR p₁)OR(p₁ XOR p₂)If(mask=(PATTERN AND mask) (1)

In Equation (1), NEGATE is an operator for changing ‘0’ to ‘1’, and changing ‘1’ to ‘0’. For example, ‘NEGATE(1100)’ is ‘0011’. pₙ denotes an n-th packet. ‘mask’ denotes a mask defined by a mask signature. In the example where a second line of Equation (1) is true, this denotes coincidence.

In the example where the change pattern is further defined, the detector determines whether a value of a portion or all of bit lines designated by the mask between a plurality of packets increases or decreases by a predetermined amount of change. In the example where the packet size is further defined, the detector determines whether a size of each of the plurality of packets coincides with the packet size. For example, the mask, the change pattern, and the packet size are the same as ‘mask’, ‘increase’, and ‘size_check’ of Table 1, respectively. In addition, the detector stores the examination result, that is, coincidence and non-coincidence.

After that, the detector proceeds to step 313 to determine whether the number of input packets exceeds a third threshold. The third threshold defines a minimum number of packets that allows start of a comparison operation. For example, the third threshold is the same as ‘min_count’ of Table 1. That is, in the example where the number of accumulated examination results is insufficient, a ratio cannot reflect an accurate identification result. Therefore, the detector calculates a ratio only when a predetermined number of packets are accumulated and so a predetermined number of examination results are accumulated.

When the number of input packets exceeds the third threshold, the detector proceeds to step 315 to calculate a coincide ratio. That is, the detector calculates a ratio of the number of coincidence to the number of all examination results using at least one of examination results to be stored in step 311 and examination results stored in advance.

Subsequently, the detector proceeds to step 317 to determine whether the coincide ratio exceeds a fourth threshold. The fourth threshold denotes a ratio in which comparison results should coincide for being determined as a relevant application. For example, the fourth threshold is the same as ‘pattern_hit_rate’ of Table 1. When the coincide ratio is less than the fourth threshold, the detector returns to step 301 to stand by an input of the next packet.

In contrast, when the coincide ratio exceeds the fourth threshold, the detector proceeds to step 319 to determine that a packet flow that is currently examined belongs to a relevant application. Here, the relevant application denotes an application corresponding to a mask signature used for the present procedure.

In addition to the procedure described with reference to FIG. 3, for more accurate application identification, in the example where an examination result of non-coincidence occurs, a procedure for controlling the number of all packets may be further added. Referring to the above described procedure, one examination result is derived from a plurality of successively input packets. Therefore, even though only one packet does not coincide, non-coincidences occur as many as the number of packets used for one time of examination.

For example, a case of comparing three packets is assumed. In the example where a packet A, a packet B, a packet C, a packet D, a packet E, and a packet F are sequentially input and only the packet D does not coincide, an examination result of the packets A-B-C is coincidence, an examination result of the packets B-C-D subsequently performed is non-coincidence, and an examination result of the packets C-D-E and an examination result of the packets D-E-F subsequently performed are also non-coincidence. That is, three times of non-coincidence are generated by one packet that has deviated from a pattern. Therefore, examination results of non-coincidence may be calculated greater than the number of packets that actually do not coincide.

Therefore, to prevent a phenomenon that examination results of non-coincidence are calculated unreasonably much, the present disclosure may use a variable ‘no_count’. ‘no_count’ increases by ‘the number of packets used for one time of examination-1’ (ex: increases by 2 when three packets are used) when an initial non-coincidence examination result occurs. In addition, in case of calculating the number of all packets, the detector subtracts ‘no-count’ from the number of actually input packets. That is, when calculating a coincidence ratio in step 315, the detector uses ‘the number of actually input packets-no_count’ as the number of all packets. Also, when calculating the number of input packets in step 313, the detector uses ‘the number of actually input packets-no_count’ as the number of input packets.

According to another embodiment of the present disclosure, some of the procedure of the embodiment illustrated in FIG. 3 may be omitted. For example, at least one of step 307, step 309, and step 313 may be omitted. In the example where step 307 is omitted, the detector performs examination without skipping examination with respect to a predetermined number of packets after an initial flow starts. In the example where step 309 is omitted, the detector may repeat examination until an application is identified, or may avoid an infinite repetitive operation using a separate condition. In the example where step 313 is omitted, the detector calculates a ratio from a point where a minimum number of packets has been stored. According to still another embodiment of the present disclosure, another step besides step 307, step 309, and step 313 of the procedure illustrated in FIG. 3 may be omitted.

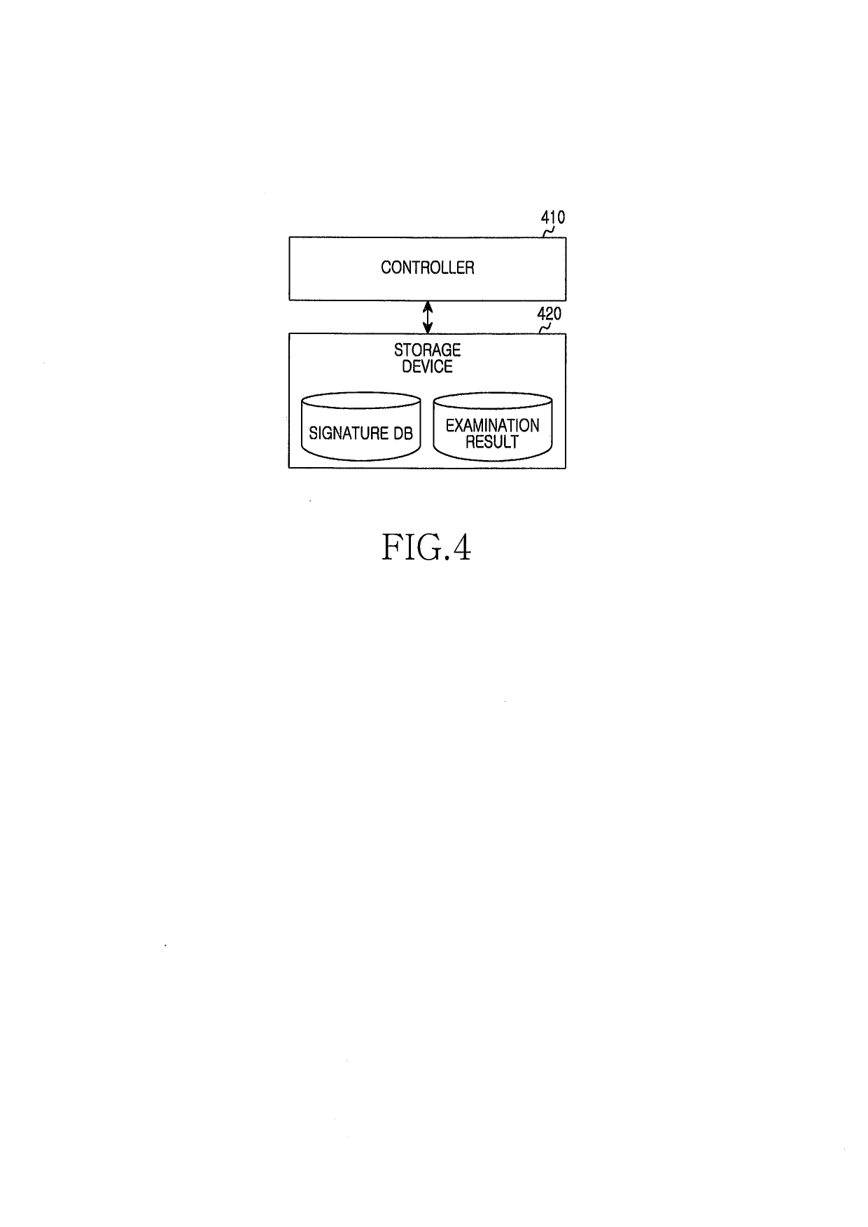

The method described above in relation with FIG. 4 under of the present invention may be provided as one or more instructions in one or more software modules, or computer programs stored in an electronic device including a portable terminal.

FIG. 4 illustrates a block diagram of an application identify apparatus in a communication system according to an exemplary embodiment of the present disclosure.

Referring to FIG. 4, the application identify apparatus includes a controller 410 and a storage device 420. The controller 410 performs an operation required for identifying the application. For example, the controller 410 performs a function of the detection engine of FIG. 1. The storage device 420 stores information required for identifying the application, data generated temporarily, etc. For example, the storage device 420 stores a mask signature DB, a matching candidate table, examination results, etc. In addition, the storage device 420 provides stored data in response to a request of the controller 410. Particularly, according to the present disclosure, the controller 410 performs the procedure illustrated in FIG. 3.

An operation of the controller 410 is described below specifically. When the packet is input, the controller 410 extracts a portion of the input packet and stores the same in the storage device 420. According to another embodiment, the entire packet may be stored. Subsequently, the controller 410 determines whether a comparable number of packets have been accumulated, and whether the number of input packets exceeds a first threshold. Here, the first threshold is a variable defined for skipping examination with respect to a predetermined number of packets after a flow starts.

When the comparable number of packets is accumulated and the number of input packets exceeds the first threshold, the controller 410 determines whether the number of input packets exceeds a second threshold. The second threshold defines a threshold of packets for continuing the present procedure. When the number of the input packets exceeds the second threshold, the controller 410 excludes a mask signature currently in use from candidates and performs the present procedure using a mask signature corresponding to a different application. In contrast, when the number of input packets does not exceed the second threshold, the controller 410 examines packets according to a mask, a change pattern, and a packet size, and stores examination results.

After that, the controller 410 determines whether the number of input packets exceeds a third threshold. The third threshold defines a minimum number of packets that allows start of a comparison operation. When the number of input packets exceeds the third threshold, the controller 410 calculates a coincidence ratio. When the coincidence ratio exceeds a fourth threshold, the controller 410 proceeds to step 319 to determine that the packet flow that is currently examined belongs to a relevant application. The fourth threshold denotes a ratio in which comparison results should coincide for being determined as a relevant application.

In addition, the controller 410 may use a variable ‘no_count’. In this example, in case of calculating the number of all packets, the controller 410 subtracts ‘no_count’ from the number of actually input packets. That is, when calculating the coincidence ratio, the controller 410 uses ‘the number of actually input packets-no_count’ as the number of all packets. Also, when calculating the number of input packets, the controller 410 uses ‘the number of actually input packets-no_count’ as the number of input packets.

The present invention may be implemented in an electronic device including a portable terminal such as, for example, a smart phone and a mobile telecommunication terminal. Hereunder, a portable terminal is used as an example for the electronic device.

A communication system updates a communication behavior of a specific client via a data structure standardized on a packet basis to collect and analyze the behavior in real-time, so that application detection is possible even when data is encrypted.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for identifying an application to which a packet flow belongs, the method comprising:
selecting characteristic information of a first application;
examining bit lines of a position designated by a mask included in the characteristic information from packets transferred via the packet flow;
calculating a ratio of a number of examination results of coincidence to a number of all input packets; and
when the ratio exceeds a first threshold included in the characteristic information, determining that the packet flow belongs to the first application.

2. The method of claim 1, wherein examining the bit lines of the position designated by the mask comprises:
determining whether the bit lines of the position designated by the mask in respective packets are the same; and
when the bit lines are the same, determining an examination result as a coincidence.

3. The method of claim 1, wherein examining the bit lines of the position designated by the mask comprises:
determining whether at least a portion of the bit lines of the position designated by the mask in respective packets increases by a predetermined size; and
when the at least a portion of the bit lines increases by the predetermined size, determining an examination result as coincidence.

4. The method of claim 1, wherein examining the bit lines of the position designated by the mask comprises:
determining whether a size of the packets is the same as a size defined by the characteristic information.

5. The method of claim 1, wherein examining the bit lines of the position designated by the mask comprises:
after the number of input packets exceeds a second threshold included in the characteristic information, examining the bit lines of the position designated by the mask.

6. The method of claim 1, further comprising:
when the number of input packets exceeds a third threshold included in the characteristic information, determining that the packet flow does not belong to the first application; and
selecting characteristic information of a second application.

7. The method of claim 1, wherein the calculating of the ratio comprises:
after the number of input packets exceeds a fourth threshold, calculating the ratio.

8. The method of claim 1, further comprising:
when an examination result of non-coincidence occurs, reducing the number of all input packets by n,
wherein n is a value obtained by subtracting 1 from the number of packets used for one time of examination.

9. The method of claim 1, further comprising:
extracting a portion of packets transferred via the packet flow.

10. The method of claim 1, wherein the characteristic information comprises at least one of the mask designating a position of a bit to be compared between packets, the first threshold representing a minimum ratio for being determined as a relevant application, a second threshold which is a number of input packets allowing start of examination, a third threshold which is a number of input packets allowing end of examination, a fourth threshold which is a number of input packets allowing start of ratio calculation, information and an amount of change designating a position and a length of a portion showing a pattern where a value changes constantly in a plurality of packets among bit lines designated by the mask, or a size of a packet transferred via the packet flow.

11. The method of claim 10, wherein the size of the packet is included in the characteristic information when a size of packets of a relevant application is constant.

12. The method of claim 10, wherein the information and the amount of change designating the position and the length of the portion showing the changing pattern are included in the characteristic information when at least a portion of the bit line designated by the mask shows a pattern where a value changes constantly in a plurality of packets.

13. An electronic device configured to identify an application to which a packet flow belongs, the device comprising:
a storage device configured to store characteristic information corresponding to at least one application; and
a controller configured to select characteristic information of a first application, examine bit lines of a position designated by a mask included in the characteristic information from packets transferred via the packet flow, calculate a ratio of a number of examination results of coincidence to a number of all input packets, and when the ratio exceeds a first threshold included in the characteristic information, determine that the packet flow belongs to the first application.

14. The device of claim 13, wherein the controller is configured to determine whether the bit lines of the position designated by the mask in respective packets are the same, and when the bit lines are the same, the controller is configured to determine an examination result as coincidence.

15. The device of claim 13, wherein the controller is configured to determine whether at least a portion of the bit lines of the position designated by the mask in respective packets increases by a predetermined size, and when the at least a portion of the bit lines increases by the predetermined size, the controller is configured to determine an examination result as coincidence.

16. The device of claim 13, wherein the controller is configured to determine whether a size of the packets is the same as a size defined by the characteristic information.

17. The device of claim 13, wherein after the number of input packets exceeds a second threshold included in the characteristic information, the controller examine is configured to the bit lines of the position designated by the mask.

18. The device of claim 13, wherein when the number of input packets exceeds a third threshold included in the characteristic information, the controller is configured to determine that the packet flow does not belong to the first application, and selects characteristic information of a second application.

19. The device of claim 13, wherein after the number of input packets exceeds a fourth threshold, the controller is configured to calculate the ratio.

20. The device of claim 13, wherein when an examination result of non-coincidence occurs, the controller is configured to reduce the number of all input packets by n, and n is a value obtained by subtracting 1 from the number of packets used for one time of examination.

21. The device of claim 13, wherein the controller is configured to extract a portion of packets transferred via the packet flow.

22. The device of claim 13, wherein the characteristic information comprises at least one of the mask designating a position of a bit to be compared between packets, the first threshold representing a minimum ratio for being determined as a relevant application, a second threshold which is a number of input packets allowing start of examination, a third threshold which is a number of input packets allowing end of examination, a fourth threshold which is a number of input packets allowing start of ratio calculation, information and an amount of change designating a position and a length of a portion showing a pattern where a value changes constantly in a plurality of packets among bit lines designated by the mask, or a size of a packet transferred via the packet flow.

23. The device of claim 22, wherein the size of the packet is included in the characteristic information when a size of packets of a relevant application is constant.

24. The device of claim 22, wherein the information and the amount of change designating the position and the length of the portion showing the changing pattern are included in the characteristic information when all or a portion of the bit line designated by the mask shows a pattern where a value changes constantly in a plurality of packets.
